(19) United States
(12) Patent Application Publication
(10) Pub. No.: US 2008/0262927 A1
(43) Pub. Date: Oct. 23, 2008

(54) SYSTEM, METHOD, AND PROGRAM FOR SELECTING ADVERTISEMENTS

(76) Inventors: Hiroshi Kanayama, Yokohama-shi (JP); Tetsuya Nasukawa, Fujisawa-shi (JP); Risa Nishiyama, Tokyo (JP); Hideo Watanabe, Tokyo (JP)

Correspondence Address: IBM CORPORATION, T.J. WATSON RESEARCH CENTER, P.O. BOX 218, YORKTOWN HEIGHTS, NY, 10598, US

(21) Appl. No.: 12/104,626

(22) Filed: Apr. 17, 2008

(30) Foreign Application Priority Data
Apr. 19, 2007 (JP) 2007-110559

(51) Int. Cl. G06Q 30/00

(52) U.S. Cl. 705/14

(57) ABSTRACT

A system, a method, and a program for selecting advertisements for displaying advertisements associated with content when the content is sent via communication means such as the Internet. Providing suppression of the appearance of an advertisement on the internet when one role label, “Victimizer”, “Victim” or “Beneficiary” is systematically assigned to a corresponding thing referred to in the article: a company, a person, or a product. The advertisement selection mechanism controls suppression of the appearance of advertisements associated with such role labels and can calculate the affinity or linkage between an article and the advertisement as a value. The suppression of the advertisement occurs by subtracting the value of the affinity. The degree of suppression by role labels is preferentially decreased over time.

### CROSS-REFERENCE TO RELATED APPLICATION

This application claims priority under 35 U.S.C. § 119 from Japanese Patent Application No. 2007-110559 filed Apr. 19, 2007, the entire contents of which are incorporated herein by reference.

### BACKGROUND OF THE INVENTION

The present invention relates to a system, a method, and a program for selecting advertisements for displaying advertisements associated with content when the content is sent via communication means such as the Internet.

Hitherto, a technique for selecting an advertisement that is most suitable to the condition from a group of provided advertisements and displaying the advertisement when, for example, a newspaper article is placed on a web site is known. This is very important in the sense that, by linking an interest in the content of a web site to an advertisement that is simultaneously displayed, the effect of the advertisement can be improved.

A reference discloses a technique in U.S. Pat. No. 7,136,875. In U.S. Pat. No. 7,136,875, there is a technique for obtaining content that includes a spot available for advertising, determining an advertisement associated with the content, and combining the content with the advertisement, which has been determined as being associated with the content.

According to disclosure in U.S. Pat. No. 7,124,093, a document related to concepts of a user is analyzed to prepare a group of concepts regarding the user, and a document related to concepts of an advertiser is analyzed to prepare a group of concepts regarding the advertiser. Then, the group of concepts regarding the user is compared with the group of concepts regarding the advertiser, and an advertisement selected based on the result of the comparison is displayed on a browser.

According to disclosure in Japanese Unexamined Patent Application Publication No. 2002-366569, in a system that selects advertisements on the basis of requests from content providers, advertisers, and viewers, selection of advertisements is made more effective by establishing a hierarchy of items that constitute attributes and requests of individual parties, i.e., content providers, advertisers, and viewers, and using weighting functions for individual hierarchy levels and weighting functions based on linkages between the individual items.

According to disclosure in Japanese Unexamined Patent Application Publication No. 2003-303302, in a system that distributes advertisements together with content, content and advertising information associated with the content are linked together, a content use point is stored for each user every time the user uses the content via a network, and an advertising information viewing point is stored for each user every time the user views the advertising information associated with the content.

These known advertisement selection systems effectively work in selecting and displaying an advertisement associated with an article viewed by a user, as described above. However, displaying an advertisement associated with a viewed article without change may produce a negative effect. For example, when an advertisement of a certain product is displayed in association with an article stating that a defect occurred in the product and the manufacturer is forced to recall the product, the image of the manufacturer is hurt.

An invention proposed by the applicant to solve this problem is in the specification of Japanese Patent Application No. 2005-376579. In this application, is a closed technique associated with a step of, in a system that selects an advertisement in response to a keyword in content displayed on a web page, determining whether a sentence in which a keyword is used includes a negative evaluation. Thus, when it is determined that a sentence in which a keyword is used includes a negative evaluation, advertisements related to e, the keyword be suppressed.

However, the case where displaying an advertisement in association with a keyword creates a negative image is not limited to the aforementioned case. For example, it is assumed that a newspaper article stating that a certain car manufacturer has developed an innovative fuel-efficient engine exists. Displaying an advertisement of the car manufacturer in association with the newspaper article may give an impression that the article is what a sycophantic article that is for the benefit of the advertisement.

Alternatively, displaying an advertisement of a certain car insurance company in association with an article of a car accident may give an impression that the insurance company takes advantage of other people's unhappiness and create a negative image.

In this way, although the technique shown in the specification of Japanese Patent Application No. 2005-376579 is effective in a predetermined framework, in various cases, an advertisement prevented from giving a negative image in a more general situation. An advertiser pays a considerable cost in total over time for an Internet advertisement. When the advertisement gives a negative image s a result of such payment, cost effectiveness is not achieved, thereby resulting in a serious problem in the long term. In addition, when the content of a displayed advertisement is too close to a source article, an impression that the source article is written for the benefit of the advertisement, i.e., the source article is a sycophantic article, may be given. This may hurt the credibility of the article rather than the credibility of the advertiser and thus hurt the reputation of an organization that provides the article, such as a newspaper publishing company. Comment: put these in IDS only

### SUMMARY OF THE INVENTION

The present invention provides a system that selects an advertisement in association with content of an article on, for example, a web page, prevent the reputation of an advertiser from being hurt by suppressing display of an advertisement having a negative relationship with an article.

The present invention further provides a system that selects an advertisement in association with content of an article on, for example, a web page, suppress display of an advertisement having content that is too close to an article to reduce the possibility that the article is considered as a sycophantic article so as to prevent the reputation of a provider of the article from being hurt.

The present invention is achieved in the following steps. Specifically, in order to suppress the appearance of an advertisement that creates uncomfortable feeling among readers of web pages, blogs, and the like, one of the following three types of role label is systematically assigned to a corresponding thing, for example, a company, a person, or a product, referred to in an article.

Comment: do not use word “thing”

Victimizer—a role label that performed unfavorable action in an article of, for example, an accident or a scandal.

Victim—a role label that suffered damage in an article of, for example, an accident or a scandal.

Beneficiary—, a role label other than those described above, that is considered to enjoy some advantages when the thing is referred to in an article.

For example, in the case of an airplane accident of A Airline, A Airlinecan be said to be a victimizer for passengers. A pilot of a corresponding airplane may be also a victimizer. The passengers are victims.

Moreover, for example, it is assumed that an article stating that a manufacturer called E Electrical Appliance has developed a cleaner having an innovative mechanism is placed. In the article, since E Electrical Appliance is treated positively, E Electrical Appliance is a beneficiary.

The objects of the present invention can be only by a framework for label assignment, in which role labels “Victimizer”, “Victim”, and “Beneficiary” are used. However, in an embodiment of the present invention, in order to perform label assignment more precisely, labels “Associate of Victimizer”, “Competitor of Victimizer”, “Associate of Victim”, “Competitor of Victim”, “Associate of Beneficiary”, and “Competitor of Beneficiary” are further assigned.

Regarding determination of which label is assigned to a certain keyword in an article, ambiguity may arise. However, ambiguity can be removed by an analysis technique established in, for example, the field of text mining. For example, in that an article stating a price increases by A Airline exists. In this case, since it can be determined by a text mining technique that A Airline performed unfavorable action, the label “Victimizer” is assigned to A Airline. However, content of the unfavorable action is not an accident but a price increase, in an advertisement, the label “Beneficiary” is assigned to B Airline that is a competitor of A Airline. To this end, a database of expressions meaning harmful actions needs to be prepared.

In the case of the aforementioned airplane accident, boarding an airplane may be considered negatively. Thus, since it is determined by a text mining technique that the content of the unfavorable action is an accident, the label “Competitor of Victimizer” is assigned to B Airline, which is a competitor of A Airline.

In the present invention, both a beneficiary and a competitor of a victimizer are the same in that control is performed to suppress advertisements. However, settings can be configured in an advertisement suppression policy so that, for example, the degree of suppression in the case of a beneficiary is less than the degree of suppression in the case of a competitor of a victimizer.

Thus, it should be understood that advertisement suppression can be performed more appropriately and precisely in this way using the additional labels “Associate of Victimizer”, “Competitor of Victimizer”, “Associate of Victim”, “Competitor of Victim”, “Associate of Beneficiary”, and “Competitor of Beneficiary”.

An advertisement selection mechanism used in the present invention selects an advertisement on the basis of, for example, an article to be viewed, a viewing history, and the attribute of a reader and may be a mechanism that has been hitherto adopted. However, the advertisement selection mechanism needs to include a function of calculating affinity between an article and an advertisement, i.e., the priority of the advertisement. In the present invention, in a case where an advertisement related to a keyword to which one of the aforementioned role labels is assigned exists, when the advertisement selection mechanism calculates the priority, a certain value is subtracted from the priority. As a result, the appearance of the advertisement is suppressed, or the advertisement is less likely to appear.

In a preferred embodiment, the aforementioned role labels are used not only to suppress the appearance of an advertisement when a reader views a corresponding article but also to suppress an advertisement when the reader views another article later. However, actually, an impression given to a user fades away over time. Thus, an appropriate decay function or an appropriate decay parameter is used so that the degree of suppression decreases over time. Different decay functions or decay parameters can be used in response to, for example, the use of a web site or the type of an article.

According to the invention, on a web page on which an advertisement is displayed in association with an article, the possibility that, due to an advertisement displayed in association with an article, readers or viewers have uncomfortable feeling, unnatural feeling, and the like, or the readers or viewers consider that an article distributor distributes a sycophantic article is reduced. Thus, an advertiser can place an order for advertisements without anxiety. As a result, an owner of a web page, such as a newspaper publishing company, who accepts an order for advertisements, can capture the advertiser's confidence, so that the owner can continuously receive more orders. Moreover, an article distributor such as a newspaper publishing company can achieve credibility and enjoy a feeling of security in displaying advertisements.

### BRIEF DESCRIPTION OF THE DRAWINGS

FIG. 1 is a block diagram of computer hardware for carrying out the present invention.

FIG. 2 is a functional block diagram of a system for carrying out the present invention.

FIG. 3 shows a flowchart of a process for carrying out the present invention.

FIG. 4 shows a screen, on which, according to the present invention, an advertisement is displayed next to an article, in a browser of a client computer.

### DETAILED DESCRIPTION OF THE PREFERRED EMBODIMENTS

The invention will now be described in accordance with the drawings. These embodiments are intended to illustrate preferred modes of the present invention, and it should be understood that the scope of the invention is not intended to be limited to the particular forms disclosed. The same symbol denotes the same object throughout the drawings, except where specifically noted.

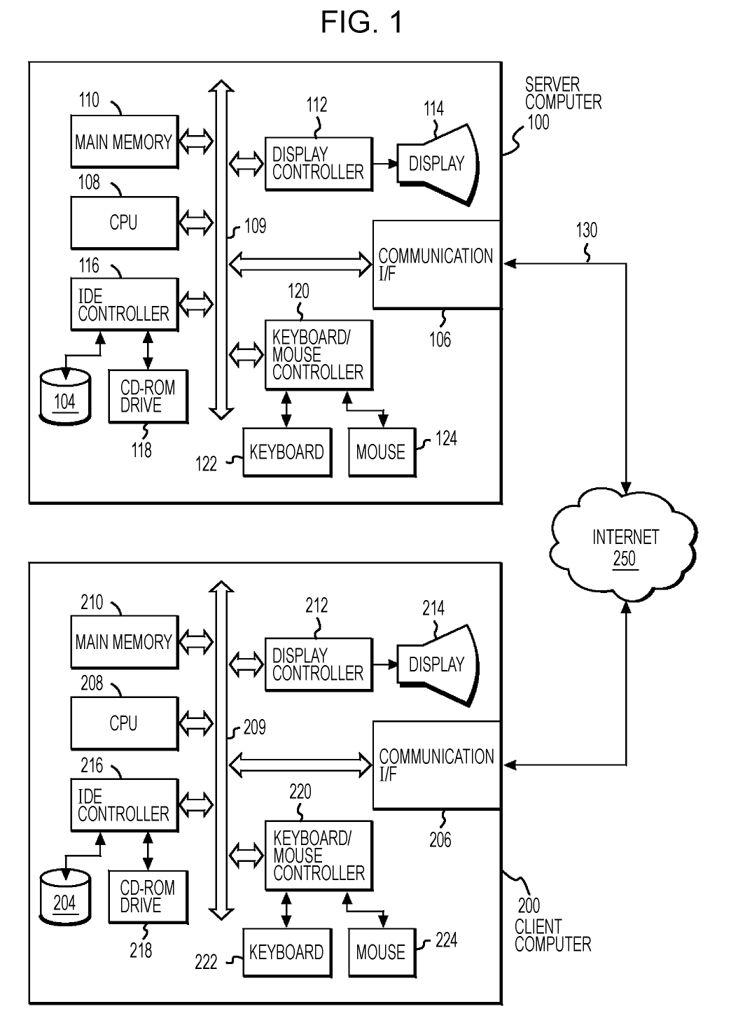

Referring to FIG. 1, a block diagram of a hardware configuration for carrying out the present invention is shown. A server computer 100 includes a CPU 108 and a main memory 110. The CPU 108 and the main memory 110 are connected to a bus 109. The CPU is preferably based on the 32-bit or 64-bit architecture. For example, Microprocessor chips such as Pentium® 4, Pentium® D, or Xeon® of Intel Corporation, or Athlon® of AMD, Inc. can be used. A display 114, such as an LCD monitor, is connected to the bus 109 via a display controller 112. The display 114 is used to display a program, such as a web browser 102 shown in FIG. 1. Moreover, a hard disk 104 and a CD-ROM drive 118 are connected to the bus 109 via an IDE controller 116. An operating system, the web browser 102, and other programs are stored in the hard disk 104 so that they can be loaded into the main memory 110. The CD-ROM drive 118 is used to additionally install a program from a CD-ROM into the hard disk 104, as necessary. Moreover, a keyboard 122 and a mouse 124 are connected to the bus 109 via a keyboard/mouse controller 120. The keyboard 122 is used to edit, for example, a role label described below. The mouse 124 is used to perform various types of operation, for example, clicking a displayed button.

A communication interface 106 is based on the Ethernet protocol and connected to the Internet 250 via a line 130. The line 130 is connected to the Internet 250 via a proxy server (not shown) for security.

The hard disk 104 stores various types of program used in the present embodiment, such as an operating system, a web browser, and a web application server program (hereinafter also called a web application server) 202, so that they can be loaded into the memory. A web application server is a program for storing content including HTML documents, XML documents, image information, and the like and sending information via networks, such as the Internet, in response to a request from a client application, such as a web browser. Any application server can be used as the web application server 202, for example, Apache Tomcat, Apache Geronimo, JBoss, WebSphere® of International Business Machines Corporation, or Internet Information Server of Microsoft Corporation. Any operating system which supports a TCP/IP communication function as standard and on which these web application servers can operate can be used as the operating system, for example, Linux®, or Windows XP® or Windows® 2000 of Microsoft Corporation. The operating system is not limited to the operating systems described here.

Moreover, Java 2 Platform, Enterprise Edition (J2EE) for enabling server-side Java®, i.e., a system of Servlet, JSP, JavaBeans, and EJB, is stored in the hard disk 104.

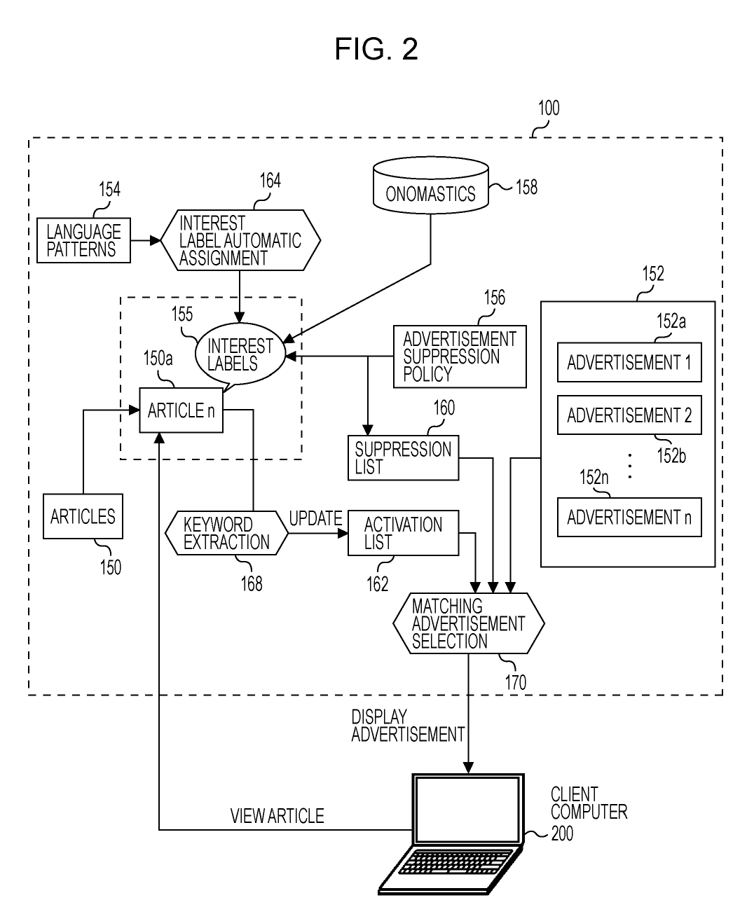

Moreover, data, such as article data 150, advertising data 152, language patterns 154, an advertisement suppression policy 156, and ontology 158 shown in FIG. 2, is recorded in the hard disk 104 so that they can be loaded into the main memory 110. The details of these pieces of data are described below in association with FIG. 2.

A client computer 200 includes a CPU 208 and a main memory 210. The CPU 208 and the main memory 210 are connected to a bus 209. Even in the client computer 200, the CPU is preferably based on the 32-bit or 64-bit architecture. For example, Pentium® 4 of Intel Corporation or Athlon® of AMD, Inc. can be used. A display 214, such as an LCD monitor, is connected to the bus 209 via a display controller 212.

Moreover, a hard disk 204 and a CD-ROM drive 218 are connected to the bus 209 via an IDE controller 216. An operating system, the web browser 102, and other programs are stored in the hard disk 204 so that they can be loaded into the main memory 210.

A communication interface 206 is based on the Ethernet protocol, physically connects the client computer 200 to the Internet 250, and provides the network interface layer in the TCP/IP communication protocol of the communication function of the operating system of the client computer 200. The configuration shown in the drawing is a wired connection configuration. Alternatively, the configuration may be a configuration in which wireless LAN connection is established according to a wireless LAN connection standard, such as IEEE 802.11a/b/g. The communication interface 206 is preferably connected to the Internet 250 via a proxy server (not shown).

The hard disk 204 stores various types of program used in this embodiment, such as an operating system and a web browser, so that these programs can be loaded into the memory. For example, Internet Explorer® of Microsoft Corporation, FireFox® of Mozilla Foundation, or Safari® of Apple Inc. can be used as a web browser used in this embodiment. Any operating system which supports a TCP/IP communication function as standard and on which these web browsers can operate can be used as the operating system, for example, Linux®, Windows XP® or Windows® 2000 of Microsoft Corporation, or Mac OS® of Apple Inc. The operating system is not limited to the operating systems described here.

FIG. 1 shows only a single unit of the client computer 200. Actually, the client computer 200 may be any computer for viewing web pages, built in the server computer 100, that include articles, and thus it can be assumed that a plurality of units of the client computer 200 are located at any places.

FIG. 2 is a block diagram showing pieces of data and processing modules for advertisement selection according to the present invention. These pieces of data and processing modules are stored in the main memory 110 in FIG. 1 and are loaded into the main memory 110 by the operating system for processing as necessary.

In FIG. 2, articles 150 that are content viewed, as web pages are, for example, individual documents of newspaper articles and blogs. In this embodiment, it is assumed that the articles 150 are newspaper articles and include a plurality of news articles written by, for example, newspaper writers and editorial writers.

A block 152 includes a plurality of pieces of advertising data 152a, 152b, . . . , 152n. Various types of format can be used as data formats for retaining advertising data. In this embodiment, the XML as described below is used. It should be noted that display of parts, for example, a header, such as <?xml version=“1.0” encoding=“Shift_JIS” ?>, a DTD, and a style sheet, is omitted here for purposes of illustration.

A segment that starts with <ad . . > and ends with </ad> is a piece of advertising data. Each piece of advertising data preferably includes an advertisement name represented by a segment that starts with <name> and ends with </name>, a category represented by <category />, a company name represented by <company />, a keyword of the advertisement represented by a segment that starts with <keyword> and ends with </keyword>. The combination of an image and an advertising message displayed on a web page as an advertisement is represented by a segment that starts with <desc graphic=“˜”> and ends with </desc>, and a URL represented by a segment that starts with <url> and ends with </url>. Advertising data is delivered by, for example, an advertising agency. An advertising agency is requested by a plurality of manufacturers, service companies, or the like to prepare each piece of advertising data as described below, in advance. In this way, the advertising agency prepares advertising data for, for example, a newspaper publishing company that manages the server computer 100. The newspaper publishing company provides a mechanism in which, when a reader views a web site of the newspaper publishing company, one or more advertisements associated with the viewed article are displayed in juxtaposition with the article. Then, the newspaper publishing company receives rates in response to the number of advertisements having been displayed or fixed rates from the advertising agency. The mechanism for charging is not the gist of the present invention. Thus, the description is omitted here.

```
    <ad id=“1”>
    <name>SP3900</name>
    <category value=“av/hw/digitalcamera” />
    <company name=“X Electrical Appliance” />
    <keyword>digital camera</keyword>
    <desc graphic=“camera.gif”>The anti-shake comfortable digital
camera SP3900 has appeared.</desc>
    <url>http://x-electronics.co.jp/</url>
    </ad>
    <ad id=“2”>
    <name>Light car of A</name>
    <category value=“auto/car” />
    <company name=“A Motor Corporation” />
    <keyword>light car</keyword>
    <desc graphic=“ak.gif”>A light car of A Motor Corporation having
a small turning radius.</desc>
    <url>http://www.A-motorcar.co.jp/</url>
    </ad>
    <ad id=“3”>
    <name>Kibi-dango</name>
    <category value=“food/sweet” />
    <desc graphic=“kibidango.gif”>We strongly recommend kibi-dango
as a souvenir of Okayama.</desc>
    <url>http://www.dango.jp/</url>
    </ad>
```

A block 154 stores language patterns. Language patterns are like the following:

[Victimizer] killed [victim].

[Victimizer] is suspected to give a bribe to [victimizer].

[Beneficiary] sells [beneficiary].

That is to say, for example, it can be determined by applying the syntax analysis technique established in, for example, the field of text mining to a sentence “A killed B.” that A is a victimizer and B is a victim. In order to absorb ambiguity in the linguistic expression, the sentence is expressed in other ways, and words in the sentence are replaced with, for example, synonyms, so that many similar expressions are stored.

A block 156 stores an advertisement suppression policy. The advertisement suppression policy specifies a decay coefficient for each role label and each web site, as described in a table below. The advertisement suppression policy is described below in detail.

A block 158 stores a dictionary (a thesaurus) that includes information, such as synonyms, and hyponyms, as an ontology. For example, the data format is as follows:

Concrete 1

Product 1.2

cellular phone 1.2.3.7.5.1

cellphone 1.2.3.7.5.1

Car 1.2.4.1

Light Car 1.2.4.1.3

Figures on the right side of each word represent a hierarchical code. For example, since Digital Camera is synonymous with Dejikame, the same code 1.2.3.7.5.1 is assigned. Since Light Car is a hyponym of Car, 1.2.4.1.3 obtained by suffixing a lower-level figure to 1.2.4.1 is assigned to Light Car.

The affinity value can be determined based on the degree of agreement obtained by comparing these codes from left to right. Moreover, when groups of competing companies and groups of allied companies, such as a parent company, a subsidiary, and a capital tie-up partner, are prepared, it can be by computer processing which of a competitive relationship, an alliance relationship, and a disinterested relationship the relationship between a certain company and another company is.

A role label automatic assignment block 164 first determines, for each of the stored articles 150, a victimizer, a victim, and a beneficiary in each of the articles 150 by performing syntax analysis using the language patterns 154. Then, a competitor and an associate of each of the victimizer, the victim, and the beneficiary are found with reference to the ontology 158. In this way, for each article, the role label automatic assignment block 164 determines, as role labels 155, not only a victimizer, a victim, and a beneficiary but also an associate of the victimizer, a competitor of the victimizer, an associate of the victim, a competitor of the victim, an associate of the beneficiary, and a competitor of the beneficiary described below in detail. Then, the role label automatic assignment block 164 adds the role labels 155 with XML tags in a segment that starts with <rolelist> and ends with </rolelist>, the type attribute being assigned to the role labels 155. An exemplary article to which role labels are assigned in this way is described below. A segment that starts with <article> and ends with </article> is an article.

```
    <article id=“1”>
    <title>X Electrical Appliance Announces New Anti-Shake Digital
Camera SP3900</title>
    <content>X Electrical Appliance (headquartered in Okayama)
launches the compact digital camera SP3900incorporating the shake
    correction function on the 18th of the month.
```

The SP3900 is a successor model to the currently available world's smallest digital camera SP3000 and incorporates the shake correction function to achieve both usability and image quality.

```
        Though the price is open, the market price is expected to be
about forty thousand yen.</content>
    <rolelist>
    <role word=“X Electrical Appliance” type=“Beneficiary”  />
    <role word=“SP3900” type=“Beneficiary” />
    <role word=“Y Optical” type=“Competitor of Beneficiary”/>
    </rolelist>
    </article>
    <article id=“2”>
    <title>A Motor Corporation Recalls 2,000 TJ WAGON</title>
    <content>A Motor Corporation held a press conference on the 9th
and announced the recall of about 2,000 TJ WAGON on sale
domestically.
```

The recall includes vehicles manufactured in 2006 and is due to a defect in a part of a rear door.

```
        An accident caused by D Transportation on the Metropolitan
Expressway on the 3rd, involving two casualties, and two other accidents
due to the defect have been reported.</content>
    <rolelist>
    <role word=“A Motor Corporation” type=“Victimizer” />
    <role word=“B Motor Corporation” type=“Competitor of
    Victimizer” />
    <role word=“D Transportation” type=“Victim”/>
    <role word=“Metropolitan Expressway” type=“Victim” />
    </rolelist>
    </article>
```

The article, to which role labels are assigned in this way, is shown as an article 150a. In principle, the aforementioned role labels 155 are systematically and automatically assigned by the role label automatic assignment block 164. However, in some cases, some of the role labels 155 can be manually assigned.

The role labels 155 assigned in this way are extracted as a suppression list 160 every time a reader views the specific article 150a via the browser of the computer 200. In this case, the advertisement suppression policy 156 gives parameters that decrease with time or the frequency of viewing in response to the types of the role labels 155 extracted into the suppression list 160. This is because a common assumption that any topic fades away from people's memory over time is taken into consideration.

On the other hand, keywords are extracted by a keyword extraction block 168 from the article viewed by the reader and stored as an activation list 162. The keyword extraction block 168 calculates the activation value for each keyword using a relatively simple algorithm that adds 2.0 for a word that appears in a title, 1.0 for a word that appears in a text, and 0.5 for a word that appears in supplemental information, for example, enclosed in parentheses. In this case, addition is not performed redundantly for a word that appears more than once in a title, a text, and the like.

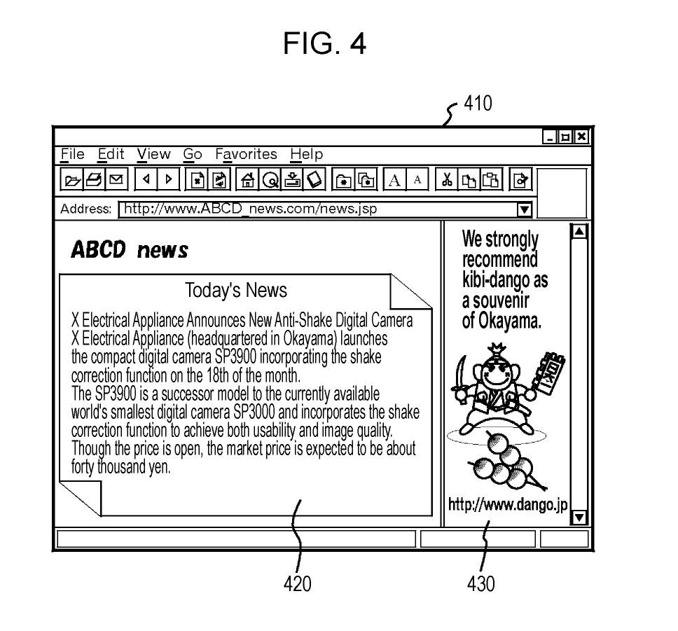

A matching advertisement selection block 170 calculates priorities on the basis of keywords included in the advertisements 152a to 152n using keywords and figures listed in the suppression list 160 and the activation list 162. Then, the matching advertisement selection block 170 selects one or more advertisements in order of priority and formats an output HTML so that, in a browser through which an article is viewed, the selected one or more advertisements are output near the article. FIG. 4 shows a status in which, in a browser 410 displayed on the screen of the client computer 200, an advertisement 430 selected according to the present invention is displayed near an article 420.

The role labels 155 and the advertisement suppression policy 156 will now be described.

First, a victimizer is a company, a person, a product, or the like that performed unfavorable action in an article of, for example, an accident or a scandal. A thing that is a victimizer in a certain article creates a very bad impression on readers. Moreover, readers will feel that the presentation of an advertisement of the thing should be suppressed. Thus, it is preferable that the appearance of an advertisement of a victimizer be strongly suppressed for a long time.

Next, a victim is a company, a person, a product, or the like that suffered damage in an article of, for example, an accident or a scandal. An object that is a victim in a certain article creates an unfavorable impression or an impression that the article is written from the standpoint of the victim on readers. Thus, the appearance of an advertisement of a victim should be properly suppressed for a short time.

Moreover, a beneficiary is a company, a person, a product, or the like, other than those described above, that enjoys some advantages when it is referred to in an article (it should be noted that the article does not necessarily describe that the beneficiary enjoyed advantages). When an advertisement related to a thing that is a beneficiary appears, readers feel a linkage between a corresponding article and the advertisement. In some cases, readers get an impression that the article is what is called a sycophantic article. Thus, the appearance of the advertisement needs to be suppressed so as not to violate the neutrality of the article.

A favorable result can be obtained only with role labels “Victimizer”, “Victim”, and “Beneficiary”. However, in a preferred embodiment of the present invention, the role labels 155 are extended using the ontology 158 so that labels of an associate and a competitor of each of a victimizer, a victim, and a beneficiary are assigned. An associate is an allied company of a certain company, an industry to which the company belongs, the category of a certain product, a product similar to the product, or the like. A competitor competes with a certain company, a certain product, or the like, and is automatically assigned when the competitive relationship is described in the ontology. Since an associate and a competitor each involve the following risks when an advertisement is displayed, advertisements are suppressed for an associate and a competitor in addition to a victimizer, a victim, and a beneficiary.

Associate of Victimizer A very bad impression is created, as is the case with the victimizer.

Competitor of Victimizer An impression that a corresponding advertisement takes advantage of a weakness in the victimizer is created.

Associate of Victim A corresponding article may be considered as a sycophantic article in contemplation of readers' sympathy.

Competitor of Victim An impression that a corresponding advertisement takes advantage of the status of the victim is created.

Associate of Beneficiary A corresponding article is considered as a sycophantic article.

Competitor of Beneficiary Confusion is created because of lack of harmonization with a corresponding article.

An example of the advertisement suppression policy 156 for the role labels 155 defined as described above is shown below.

TABLE 1

| | Newspaper Site | Blog Site |
|---|---|---|
| Victimizer | a = 20, b = 0.8 | a = 20, b = 0.8 |
| Victim | a = 10, b = 0.2 | a = 10, b = 0.8 |
| Beneficiary | a = 15, b = 0.1 | a = 0, b = 1 |
| Associate of Victimizer | a = 15, b = 0.6 | a = 20, b = 0.8 |
| Competitor of Victimizer | a = 15, b = 0.2 | a = 10, b = 0.8 |
| Associate of Victim | a = 8, b = 0.2 | a = 10, b = 0.8 |
| Competitor of Victim | a = 8, b = 0.1 | a = 5, b = 0.8 |
| Associate of Beneficiary | a = 10, b = 0.2 | a = 0, b = 1 |
| Competitor of Beneficiary | a = 10, b = 0.1 | a = 5, b = 0.5 |

As shown in this table, for each type of web site, the advertisement suppression policy specifies an initial value a and a decay coefficient b for each of “Victimizer”, “Victim”, “Beneficiary”, “Associate of Victimizer”, “Competitor of Victimizer”, “Associate of Victim”, “Competitor of Victim”, “Associate of Beneficiary”, and “Competitor of Beneficiary”. The degree of suppression is expressed by equation y=a·b^{t}. In this embodiment, t is the frequency of viewing. For example, in the case of “Victimizer”, since the impact is strong, a large number is assigned as the initial value a, and the decay coefficient b is relatively close to one. On the other hand, in the case of “Competitor of Victim”, since the linkage is relatively weak in the context of advertisement suppression, a small number is assigned as the initial value a, and the decay coefficient b is relatively close to zero.

The advertisement suppression policy varies with the type of a web site, as shown in the table above. For example, an examination of treatment of a victim shows that the degree of advertisement suppression is relatively rapidly decreased for newspaper sites, i.e., b=0.2. This is because, regarding newspaper articles, the number of articles is large, and thus an impression about a victim relatively rapidly fades away. On the other hand, regarding blogs, a victim may be a personal acquaintance of a reader, and the impression remains for a long time. Thus, setting is performed so that a decrease in the degree of advertisement suppression is moderate, i.e., b=0.8.

In this case, a fractional function such as a/(b+t) may be effective as an equation for the degree y of suppression. Thus, the function is determined based on the experimental adequacy. An appropriate function that monotonously decreases with t can be selected as the degree y≡y(a, b, t) of suppression based on the adequacy.

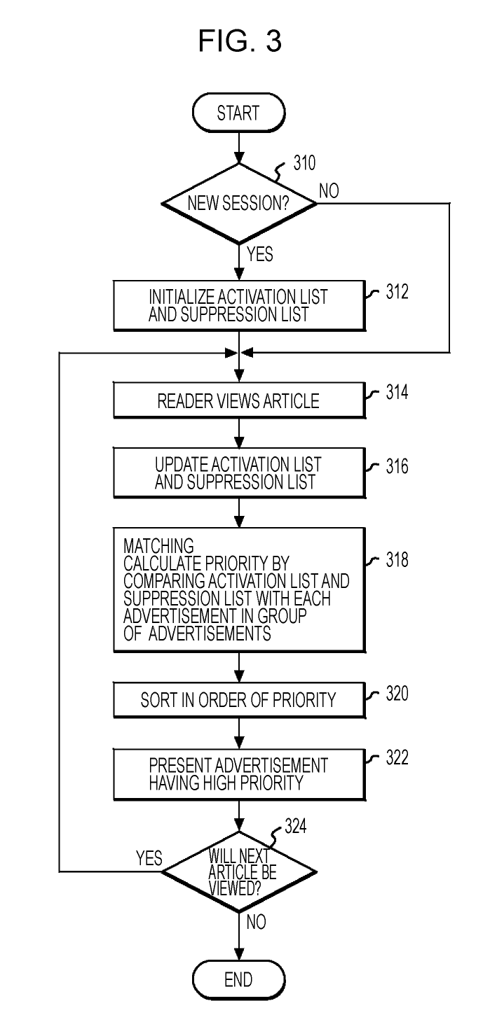

The operations performed in the individual blocks shown in FIG. 2 will now be described in detail with reference to a flowchart in FIG. 3.

In FIG. 3, in step 310, it is determined whether a corresponding session is a new session. A new session means that a reader has accessed a corresponding web site for the first time. To be more exact, the reader has accessed the web site for the first time using the specific browser 410 (FIG. 4) of the client computer 200 currently used by the reader. In this embodiment, such session management is implemented using the concept of a session object in JSP. Specifically, a part of the code is described below.

When it is found, bison=request.GetSession(true); in the code below that a previous session exists, the existing session object is obtained. Otherwise, a new session object is created. When the session is not a new session, GetArrayList( ) is called in relation to session, and an existing suppression list and an existing activation list are obtained. When the session is a new session, in step 312, a suppression list and an activation list are newly created by, for example,

ArrayList SuppressList=new ArrayList( );

ArrayList ActivateList=new ArrayList( );

More specifically, empty lists are prepared.

```
<html><body>
<% page import=“java.util.*” %>
<%
try {
  ....
  HttpSession session = request.GetSession(true);
  .....
  }
%>
</body></html>
```

In step 314, the reader views a certain article. Then, in response to the viewing, in step 316, the suppression list 160 is updated by the action of the advertisement suppression policy 156 shown in FIG. 2, and the activation list 162 is updated by the action of the keyword extraction block 168. The exemplary article described above in association with FIG. 2 is again described below to illustrate this operation specifically.

```
    <article id=“1”>
    <title>X Electrical Appliance Announces New Anti-Shake Digital
Camera SP3900</title>
    <content>X Electrical Appliance (headquartered in Okayama)
launches the compact digital camera SP3900 incorporating the shake
    correction function on the 18th of the month.
```

The SP3900 is a successor model to the currently available world's smallest digital camera SP3000 and incorporates the shake correction function to achieve both usability and image quality.

```
        Though the price is open, the market price is expected to be
about forty thousand yen.</content>
    <rolelist>
    <role word=“X Electrical Appliance” type=“Beneficiary”/>
    <role word=“SP3900” type=“Beneficiary” />
    <role word=“Y Optical” type=“Competitor of Beneficiary”/>
    </rolelist>
    </article>
    <article id=“2”>
    <title>A Motor Corporation Recalls 2,000 TJ WAGON</title>
    <content>A Motor Corporation held a press conference on the 9th
and announced the recall of about 2,000 TJ WAGON on sale domestically.
```

The recall includes vehicles manufactured in 2006 and is due to a defect in a part of a rear door.

An accident caused by D Transportation on the Metropolitan Expressway on the 3rd, involving two casualties, and two other accidents due to the defect have been reported.

</content>
<rolelist>
<role word=“A Motor Corporation” type=“Victimizer” />
<role word=“B Motor Corporation” type=“Competitor of Victimizer” />
<role word=“D Transportation” type=“Victim”/>
<role word=“Metropolitan Expressway” type=“Victim” />
</rolelist>
</article>

It is assumed here that the reader has viewed an article 1. Then, the keyword extraction block 168 generates the activation list 162 (FIG. 2), as described below, using the algorithm which adds 2.0 for a word that appears in a title, 1.0 for a word that appears in a text, and 0.5 for a word that appears in supplemental information. For example, the above, enclosed in parentheses, does not perform addition redundancy for a word that appears more than once in a title, a text, and the like. The score of activation of each keyword is indicated by “score=” described below. This algorithm for generating an activation list is an example, and it should be noted that the present invention is not limited to this algorithm. When the session is a new session at the time of viewing of the article 1 by the reader, the activation list is empty. Thus, the following content is simply added to the activation list.

<activate word=“X Electrical Appliance” score=“3.0” />
<activate word=“Okayama” score=“0.5” />
<activate word=“SP3900” score=“3.0” />
<activate word=“digital camera” score=“1.0” />

Simultaneously or subsequently, regarding a segment that starts with <rolelist> and ends with </rolelist> in the viewed article, the advertisement suppression policy 156 applies parameters stored in the advertisement suppression policy 156 to corresponding role labels with reference to the word attribute of the role to generate the suppression list 160 (FIG. 2). When the session is a new session at the time of viewing of the article 1 by the reader, the suppression list is empty. Thus, the following content is simply added to the suppression list. As shown below, the parameters a and b in the advertisement suppression policy 156 are put in “score=” and “decay=”, respectively.

<suppress word=“X Electrical Appliance” score=“15.0” decay=“0.1” />
<suppress word=“SP3900” score=“15.0” decay=“0.1” />
<suppress word=“Y Optical” score=“15.0” decay=“0.2” />

Next, in step 318, the priorities of the advertisements 152a to 152n are calculated by matching the activation list and the suppression list with the advertisements 152a to 152n. In this embodiment, the priorities are calculated using an equation described below. In this equation, activation list (s) is the score of a keyword s in the activation list. Similarly, suppression list (s) is the score of a keyword s in the suppression list. It is assumed that both activation list (s) and suppression list (s) return zero when a keyword s does not exist in the corresponding lists.

[E1]

Σ(activation list (s)−suppression list (s))

where s ε Keywords of Advertisement

The advertising data described above in association with FIG. 2 is again described below for the convenience.

```
    <ad id=“1”>
    <name>SP3900</name>
    <category value=“av/hw/digitalcamera” />
    <company name=“X Electrical Appliance” />
    <keyword>digital camera</keyword>
    <desc graphic=“camera.gif”>The anti-shake comfortable digital
camera SP3900 has appeared.</desc>
    <url>http://x-electronics.co.jp/</url>
    </ad>
    <ad id=“2”>
    <name>Light car of A</name>
    <category value=“auto/car” />
    <company name=“A Motor Corporation” />
    <keyword>light car</keyword>
    <desc graphic=“ak.gif”>A light car of A Motor Corporation having
a small turning radius.</desc>
    <url>http://www.A-motorcar.co.jp/</url>
    </ad>
    <ad id=“3”>
    <name>Kibi-dango</name>
    <category value=“food/sweet” />
    <desc graphic=“kibidango.gif”>We strongly recommend kibi-dango
as a souvenir of Okayama.</desc>
    <url>http://www.dango.jp/</url>
    </ad>
```

Priorities are calculated as described below using this equation.

Keywords included in the activation list are X Electrical Appliance, Okayama, SP3900, and digital camera, and keywords included in the suppression list are X Electrical Appliance, SP3900, and Y Optical.

Then, an examination of advertisement 1 shows that the advertisement 1 includes: X Electrical Appliance; Okayama; SP3900; a digital camera regarding the keywords included in the activation list; and X Electrical Appliance and SP3900 regarding the keywords included in the suppression list. Thus, the priority of the advertisement 1 is calculated as follows:

digital camera: 1.0+X Electrical Appliance: 3.0+SP3900: 3.0−X Electrical Appliance: 15−SP3900: 15.0=−23.0.

In this case, it should be understood that a prefix such as digital camera: is attached just for the convenience, and calculation is performed using only parts following prefixes.

Regarding an advertisement 2, the advertisement 2 does not include any of the keywords included in the activation list and the suppression list. Thus, the priority is simply zero.

Regarding an advertisement 3, the advertisement 3 includes only Okayama in the activation list. Thus, the priority of the advertisement 3 is 0.5.

As a result, when the advertisements are sorted in order of priority in step 320, the priority of the advertisement 3 is highest. Thus, in step 322, the advertisement 3 is displayed in association with the article 1 in the browser of the client computer 200. FIG. 4 shows this status. Specifically, in FIG. 4, the presentment 420 corresponding to the article 1 appears in the browser 410 displayed on the display 214 (FIG. 1) of the client computer 200, and the presentment 430 corresponding to the advertisement 3 appears next to the presentment 420. When an advertisement is selected using only the activation list as in the known arts, the score of the advertisement 1 is highest. In this case, in FIG. 4, the advertisement of the digital camera of X Electrical Appliance is selected for the article of the digital camera of X Electrical Appliance. This increases the possibility that readers suspect that the article 420 is a sycophantic article.

In this embodiment, the articles and advertisements are expressed in XML, as described above. On the other hand, general browsers do not necessarily include a function of rendering and displaying XML. Thus, in this embodiment, although not illustrated, appropriate style sheet information is attached before the articles and advertisements are sent to the browser 410 of the client computer 200 so that the articles and advertisements are converted into HTML.

In step 324, it is determined whether the reader views the next article. When it is determined that the reader does not view the next article, the process is completed. After the process is completed, when the reader views the web site with the same browser of the same client computer 200 later, the object of the previous session is obtained by processing HttpSession session=request.GetSession(true); in JSP, and the suppression list 160 and the activation list 162 stored with the session ID are obtained.

On the other hand, in step 324, it is assumed that the reader views the next article. In this case, the process returns to step 314, and then step 316 where the activation list 162 and the suppression list 160 are updated in response to the viewed article is started again. It is assumed here that the reader views an article 2. In this case, entries based on the article 2 are added to existing entries in the activation list 162. Finally, the activation list 162 described below is obtained. In this case, although not described above, in this embodiment, it is assumed that the score of a keyword that appeared in a previous article, and has not appeared in the current article is multiplied by 0.8. This is because it is appropriate to think that the effect of an activation keyword that appeared in the past gradually decreases. On the other hand, a keyword that appeared in the past and has appeared in the current article finally has no duplicate entry and has an initial score. Moreover, an entry having a score that is lower than a threshold value (for example, 0.01) may be deleted so as to prevent the activation list from expanding.

<activate word=“X Electrical Appliance” score=“2.4” />
<activate word=“Okayama” score=“0.4” />
<activate word=“SP3900” score=“2.4” />
<activate word=“digital camera” score=“0.8” />
<activate word=“A Motor Corporation” score=“3.0” />
<activate word=“TJ WAGON” score=“3.0” />
<activate word=“D Transportation” score=“1.0” />
<activate word=“Metropolitan Expressway” score=“1.0” />

On the other hand, regarding a segment that starts with <rolelist> and ends with </rolelist> in the article 2, the advertisement suppression policy 156 applies parameters stored in the advertisement suppression policy 156 to corresponding role labels with reference to the word attribute of the role to add entries to the suppression list 160 (FIG. 2). The added entries have individual initial scores. When any one of the added entries is already included in the suppression list 160, the entry is replaced with an entry having an initial score so that no duplicate entry exists. On the other hand, the score of an entry that is originally included in the suppression list 160 and is not included in the added entries is multiplied by a decay coefficient specified in “decay=”, and the updated score is put in “score=”. Thus, the suppression list 160 described below is obtained. Moreover, an entry having a score that is lower than a threshold value (for example, 0.01) may be deleted so as to prevent the suppression list from expanding.

<suppress word=“X Electrical Appliance” score=“1.5” decay=“0.1” />
<suppress word=“SP3900” score=“1.5” decay=“0.1” />
<suppress word=“Y Optical” score=“3.0” decay=“0.2” />
<suppress word=“A Motor Corporation” score=“20.0” decay=“0.8” />
<suppress word=“B Motor Corporation” score=“15.0” decay=“0.6” />
<suppress word=“D Transportation” score=“10.0”decay=“0.2” />
<suppress word=“Metropolitan Expressway” score=“10.0” decay=“0.2” />

In step 318, the priorities of the advertisements 1 to 3 are calculated using the activation list and the suppression list updated in this way, as described below.

Regarding the advertisement 1,

digital camera: 0.8+X Electrical Appliance: 2.4+SP3900: 2.4−X Electrical Appliance: 1.5−SP3900: 1.5=2.6.

Regarding the advertisement 2,

A Motor Corporation: 3.0+TJ WAGON: 3.0+D Transportation: 1.0+

### Metropolitan Expressway: 1.0−A Motor Corporation: 20.0−B Motor Corporation: 15.0−DTransportation: 10.0−Metropolitan Expressway: 10.0=−47.0.

Regarding the advertisement 3,

Okayama: 0.4=0.4.

As a result of performing sorting in order of priority in step 320, the advertisement 1 having the highest score among the three advertisements is selected. In step 322, the advertisement 1 selected in this way is displayed in association with the article 2 in the browser of the client computer 200. That is to say, the advertisement of the digital camera is displayed next to the article of the recall by A Motor Corporation. Thus, uncomfortable feeling is not created. Moreover, when an advertisement is selected using only the activation list as in the known arts, the advertisement 2, i.e., the advertisement of A Motor Corporation, is displayed next to the article of the recall by A Motor Corporation in the browser. This accelerates the collapse of credit of A Motor Corporation, and the advertisement produces an adverse effect.

In the aforementioned embodiment, a history is recorded for each session by a session management mechanism of JSP, and a suppression list and an activation list are selected. The embodiment can be also implemented using an existing mechanism of server-side Java, i.e., Servlet, JavaBeans, EJB, and the like. Comment: trademarks?

Moreover, in the case of server-side Java, a suppression list and an activation list are stored on the server side for the session ID of each client. Alternatively, for a viewed HTML file, a suppression list and an activation list may be stored in a local disk of a client computer as cookies by JavaScript operating on the client side. When cookies are used, similar processing can be performed using CGI in Perl, PHP, or the like that operates on the server side.

Moreover, in the aforementioned embodiment, a status in which only one advertisement selected for an article is displayed is shown. Actually, two, three, or any number of advertisements in response to the screen layout can be selected and displayed in order of priority.

Moreover, in the aforementioned embodiment, articles, advertisements, an activation list, and a suppression list are all expressed in XML. However, this is just an embodiment, and those in the art should understand that any data format with which a computer can manage lists, for example, CSV or database file such as DB2™, can be used. The arrangement of the present invention fits a content management system (CMS) that has been recently used frequently, and thus can be suitably used to distribute advertisements from a content management system using a web server.

1. A Computer implemented advertisement selection system for selecting an advertisement associated with a content, advertisement selection system comprising:
means for storing the content that includes a plurality of first keywords to which a plurality of role labels are assigned;
means for storing a plurality of advertisements each including a plurality of third keywords;
means for calculating a priority for each of the plurality of advertisements, so that, when each of the plurality of third keywords included in each of the plurality of advertisements corresponds to one of a plurality of second keywords, to which the plurality of role labels are assigned, out of the plurality first keywords in the content, the priority is decreased; and,
means for selecting a one or more advertisements based on a plurality of calculated priorities; and wherein the computer assigns the plurality of role labels based on a syntactic relations between the—plurality of second keywords to which the plurality of role labels are to be assigned in the content.

2. The advertisement selection system according to claim 1 wherein the plurality of role labels correspond to at least one of a victim, a victimizer, a beneficiary, an associate of a victim, a competitor of a victim, an associate of a victimizer, a competitor of a victimizer, an associate of a beneficiary, and a competitor of a beneficiary.

3. The advertisement selection system according to claim 2, further comprising:
means for storing an advertisement suppression policy that defines, for each of the plurality of role labels, an initial value that is a base for a score of one of the plurality of second keywords to which the a role label is assigned, a score being used in a priority calculation, and a decay coefficient of the score due to sequential viewing; and,
means for creating and selecting An on a basis of a fourth plurality of keywords extracted from a viewed content; and
means for creating a suppression list on the basis of the second plurality of keywords associated with the plurality of role labels, wherein the a priority is calculated so that the priority is increased when any of the third plurality of keywords included in each of the advertisements, is included in an activation list and the priority is decreased when any of the third plurality of keywords included in each of the advertisements is included in the suppression list.

4. An advertisement selection system, constructed in a computer system that includes a web server, for selecting and displaying an advertisement associated with -content by processing in the computer system, the advertisement selection system comprising:
means for storing content that includes a first plurality of keywords, a plurality of role labels being assigned to a second plurality of keywords out of the first plurality of keywords;
means for storing a plurality of advertisements each including a third plurality of keywords;
means for enabling a reader to view the advertisements by a function of the web server;
means for extracting the second plurality of keywords, in response to viewing of the content by a reader, to which the plurality of role labels are assigned, included in a viewed content;
means for creating an activation list, for selecting the advertisements, based on a fourth plurality of keywords, extracted from the viewed content, the activation list including the fourth plurality of keywords;
means for creating a suppression list, for suppressing the advertisements, on a basis of the second plurality of keywords associated with the plurality of role labels, the suppression list including the second plurality of keywords;
means for calculating a priority, so that the priority is increased when any of the third plurality of keywords included in each of the advertisements is included in the activation list, and the priority is decreased when any of the third keywords included in each of the advertisements is included in the suppression list;
means for selecting one or more advertisements on the basis of the calculated priorities; and
means for displaying the selected one or more advertisements in association with the viewed content, wherein the plurality of role labels are assigned by the computer system based on a syntactic relations between a non-specific plurality of keywords to which the plurality of role labels are to be assigned in the content.

5. The advertisement selection system according to claim 4, wherein the plurality of role labels correspond to at least one of a victim, a victimizer, a beneficiary, an associate of a victim, a competitor of a victim, an associate of a victimizer, a competitor of a victimizer, an associate of a beneficiary, and a competitor of a beneficiary.

6. The advertisement selection system according to claim 5, further comprising: means for storing an advertisement suppression policy that defines, for each of the plurality of role labels, an initial value that is a base for a score of one of the second keywords to which the plurality of role label is assigned, the score being used in priority calculation, and a decay coefficient of the score due to sequential viewing.

7. The advertisement selection system according to claim 6, wherein the suppression list includes an initial values and the decay coefficients, defined in the advertisement a suppression policy, in association with the role labels of the second plurality of keywords included in the suppression list, and
means for, in response to viewing of the content by the reader, multiplying the initial values included in the suppression list by the corresponding decay coefficients and storing the results in the suppression list.

8. The advertisement selection system according to claim 7, wherein the computer system includes a Java system, whereby the activation list and the suppression list are managed and stored for each reader by a session management mechanism of the Java system.

9. A Computer implemented advertisement selection method for selecting and displaying an advertisement associated with a content using a computer system including a web server, the method comprising:
preparing content that includes a first plurality of keywords, a plurality of role labels being assigned to a second plurality of keywords out of the first plurality of keywords;
storing a content so that the content can be read by the computer system;
preparing a plurality of advertisements each including a third plurality of keywords and storing the advertisements so that the advertisements can be read by the computer system;
extracting the second plurality of keywords in response to a viewing of the content by a reader, to which the plurality of role labels are assigned, included in the viewed content;
creating an activation list, for selecting the advertisements, based on a fourth plurality of keywords extracted from the viewed content, the activation list including the fourth plurality of keywords;
creating a suppression list, for suppressing the advertisements, based on the second plurality of keywords associated with the plurality of role labels;
calculating a priority, so that the priority is increased when any of the third plurality of keywords included in each of the advertisements, is included in the activation list and the priority is decreased when any of the third plurality of keywords included in each of the advertisements, is included in the suppression list, one or more advertisements on a basis of the calculated priorities, and
displaying the selected one or more advertisements in association with the viewed content, and
wherein the plurality of role labels correspond to at least one of a victim, a victimizer, a beneficiary, an associate of a victim, a competitor of a victim, an associate of a victimizer, a competitor of a victimizer, an associate of a beneficiary, and a competitor of a beneficiary.

10. The advertisement selection method according to claim 9, further comprising a step of
storing an advertisement suppression policy that defines, for each of the role labels, an initial value that is a base for a score of one of the second plurality of keywords to which the role label is assigned, the score being used in priority calculation, and a decay coefficient of the score due to sequential viewing and;
wherein, the suppression list includes initial values and decay coefficients, defined in the advertisement suppression policy, in association with the role labels of the second plurality of keywords included in the suppression list; and,
multiplying, in response to a viewing of the content by the reader, initial values included in the suppression list by the corresponding a decay coefficients
storing the results in the suppression list.

11. The advertisement selection method according to claim 10, wherein the computer system includes a Java system, further comprising a step of
managing storing the activation list and the suppression list for each reader by a session management mechanism of the Java system, and
storing the activation list and the suppression list for each reader by a session management mechanism of the Java system.

12. A computer program product used in an advertisement selection system, constructed in a computer system that includes a web server, for selecting and displaying an advertisement associated with content by processing in the computer system, the computer program product causing the computer system to perform:
preparing a content that includes a first plurality of keywords, a plurality of role labels being assigned to a second plurality of keywords out of the first plurality of keywords;
storing the content so that the content can be read by the computer system;
preparing a plurality of advertisements each including a third plurality of keywords and storing the advertisements so that the advertisements can be read by the computer system;
extracting, in response to viewing of the content by a reader, the second plurality of keywords, to which the role labels are assigned, included in the viewed content;
creating an activation list, for selecting the advertisements, based on a fourth plurality of keywords extracted from the a viewed content;
creating a suppression list based on the second plurality of keywords associated with the role labels;
calculating a priority so that the priority is increased when any of the third plurality of keywords included in each of the advertisements is included in the activation list and the priority is decreased when any of the third plurality of keywords included in each of the advertisements is included in the suppression list, and,
selecting one or more advertisements on the basis of the calculated priorities;
displaying a selected one or more advertisements in association with the viewed content, wherein the role labels correspond to at least one of a victim, a victimizer, a beneficiary, an associate of a victim, a competitor of a victim, an associate of a victimizer, a competitor of a victimizer, an associate of a beneficiary, and a competitor of a beneficiary.

13. The computer program product according to claim 12, wherein the computer system includes a Java system, the computer program product causing the computer system to perform a step of managing and storing the activation list and the suppression list for each reader by a session management mechanism of the Java system.

14. The computer program product according to claim 12, causing a client computer connected to the web server to perform a step of storing the activation list and the suppression list so that the activation list and the suppression list can be read as cookies.
